(19) United States
(12) Patent Application Publication
(10) Pub. No.: US 2026/0148686 A1
(43) Pub. Date: May 28, 2026

(54) LIGHT-EMITTING DEVICE AND OPERATING METHOD FOR LIGHT-EMITTING DEVICE

(71) Applicant: LIGITEK ELECTRONICS CO., LTD., New Taipei City (TW)

(72) Inventor: Yi Wen Chen, New Taipei City (TW)

(73) Assignee: LIGITEK ELECTRONICS CO., LTD., New Taipei City (TW)

(21) Appl. No.: 19/347,630

(22) Filed: Oct. 1, 2025

(30) Foreign Application Priority Data
Nov. 25, 2024 (TW) 113145328

(51) Int. Cl. G09G 3/32; G09G 3/20

(52) U.S. Cl. CPC G09G 3/32; G09G 3/2092; G09G 2310/08; G09G 2320/041; G09G 2320/0626

(57) ABSTRACT

A light-emitting device and an operating method for the light-emitting device are provided. The light-emitting device includes a light-emitting diode (LED) and a control circuit. The control circuit controls the LED to provide an output light during a first period, and provides a detection signal to the LED to receive a sensing voltage value of the LED during a second period. The first period and the second period alternate and do not overlap with each other. The control circuit obtains a junction temperature of the LED according to the sensing voltage value, and compensates the output light according to the junction temperature.

### CROSS-REFERENCE TO RELATED APPLICATION

This application claims the priority benefit of Taiwan application serial no. 113145328, filed on November 25, 2024. The entirety of the above-mentioned patent application is hereby incorporated by reference herein and made a part of this specification.

### BACKGROUND

### TECHNICAL FIELD

The disclosure relates to an electronic device and an operating method for the electronic device, and more particularly, to a light-emitting device and an operating method for the light-emitting device.

### DESCRIPTION OF RELATED ART

Generally speaking, a light-emitting device may include at least one light-emitting diode (LED). The light-emitting diode may be controlled to provide an output light. In order to achieve a stable light-emitting effect or high-quality light mixing effect, the light-emitting device will compensate brightness performance of the light-emitting diode at different temperatures. Therefore, the light-emitting device is equipped with a temperature sensor to detect a temperature of the light-emitting diode during operation. However, the temperature sensor increases a volume of the light-emitting device.

### SUMMARY

The disclosure provides a light-emitting device and an operating method for the light-emitting device, which may calculate a junction temperature of a light-emitting diode and compensate brightness performance of the light-emitting diode at the junction temperature according to the junction temperature.

In an embodiment of the disclosure, a light-emitting device includes a light-emitting diode and a control circuit. The control circuit is coupled to the light-emitting diode. The control circuit controls the light-emitting diode to provide an output light during a first period, and provide a detection signal to the light-emitting diode to receive a sensing voltage value of the light-emitting diode during a second period. The first period and the second period alternate and do not overlap with each other. The control circuit obtains a junction temperature of the light-emitting diode according to the sensing voltage value, and compensates the output light according to the junction temperature.

In an embodiment of the disclosure, an operating method is used for a light-emitting device. The light-emitting device includes a light-emitting diode. The operating method includes the following. The light-emitting diode is controlled to provide an output light during a first period. A detection signal is provided to the light-emitting diode to receive a sensing voltage value of the light-emitting diode during a second period. The first period and the second period alternate and do not overlap with each other. A junction temperature of the light-emitting diode is obtained according to the sensing voltage value, and the output light is compensated according to the junction temperature.

Based on the above, the light-emitting device provides the detection signal to the light-emitting diode to receive the sensing voltage value of the light-emitting diode during the second period, obtains the junction temperature of the light-emitting diode according to the sensing voltage value, and compensates the output light according to the junction temperature. Therefore, the light-emitting device is not required to obtain the temperature of the light-emitting diode by using the temperature sensor. In this way, a volume of the light-emitting device will not be increased.

### BRIEF DESCRIPTION OF THE DRAWINGS

FIG. 1 is a schematic diagram of a light-emitting device according to an embodiment of the disclosure.

FIG. 2 is a timing diagram according to an embodiment of the disclosure.

FIG. 3 is a schematic diagram of a light-emitting device according to an embodiment of the disclosure.

FIG. 4 is a schematic diagram of a relationship between a sensing voltage value and a junction temperature according to an embodiment of the disclosure.

FIG. 5 is a schematic diagram of a compensation value lookup table according to an embodiment of the disclosure.

FIG. 6 is a flow chart of an operating method according to an embodiment of the disclosure.

FIG. 7 is a schematic diagram of a system according to an embodiment of the disclosure.

FIG. 8 is a timing diagram of a control signal according to an embodiment of the disclosure.

FIG. 9 is a schematic diagram of a relationship between a junction temperature and a brightness ratio according to an embodiment of the disclosure.

### DETAILED DESCRIPTION OF DISCLOSED EMBODIMENTS

Some embodiments of the disclosure will be described in detail with reference to the accompanying drawings. For reference numerals cited in the following descriptions, the same reference numerals appearing in different drawings are regarded as the same or similar components. The embodiments are only a part of the disclosure and do not disclose all possible implementations of the disclosure. More precisely, the embodiments are merely examples of the device and the method.

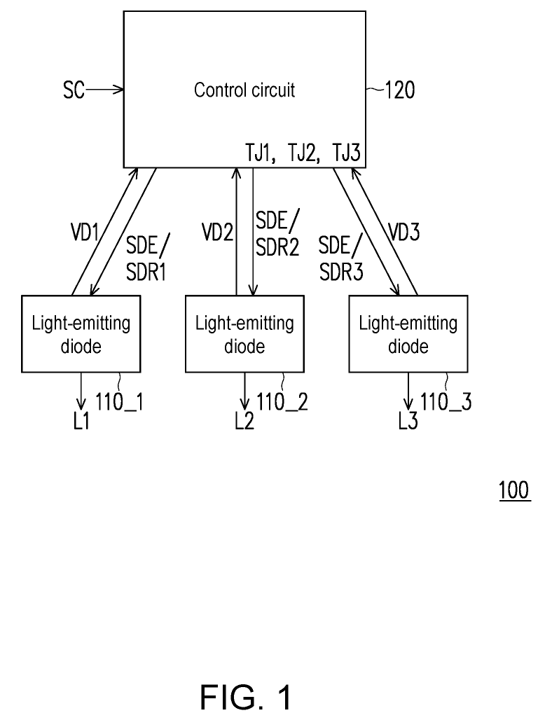

Referring to FIG. 1, FIG. 1 is a schematic diagram of a light-emitting device according to an embodiment of the disclosure. In this embodiment, a light-emitting device 100 includes light-emitting diodes 110_1, 110_2, and 110_3 and a control circuit 120. The control circuit 120 is coupled to the light-emitting diodes 110_1, 110_2, and 110_3. The control circuit 120 controls the light-emitting diodes 110_1, 110_2, and 110_3 to provide output lights L1, L2, and L3 during a first period. For example, the light-emitting diode 110_1 is controlled to provide the output light L1 during the first period. The light-emitting diode 110_2 is controlled to provide the output light L2 during the first period. The light-emitting diode 110_3 is controlled to provide the output light L3 during the first period.

In this embodiment, during a second period, the control circuit 120 provides a detection signal SDE to the light-emitting diode 110_1 to receive a sensing voltage value VD1 of the light-emitting diode 110_1. In this embodiment, the first period and the second period alternate and do not overlap with each other. In other words, the control circuit 120 provides the detection signal SDE to the light-emitting diode 110_1 to receive the sensing voltage value VD1 during the second period between the two first periods. In addition, the control circuit 120 further obtains a junction temperature TJ1 of the light-emitting diode 110_1 according to the sensing voltage value VD1 and compensates the output light L1 according to the junction temperature TJ1. The junction temperature TJ1 is a temperature of a P-N junction located at the light-emitting diode 110_1. The P-N junction is where the light-emitting diode 110_1 emits a light and is also a main position where heat is generated. Therefore, the control circuit 120 obtains the temperature of the P-N junction located at the light-emitting diode 110_1 according to the sensing voltage value VD1.

It is worth mentioning that the control circuit 120 provides the detection signal SDE to the light-emitting diode 110_1 to receive the sensing voltage value VD1 of the light-emitting diode 110_1 during the second period, and obtains the junction temperature TJ1 of the light-emitting diode 110_1 according to the sensing voltage value VD1, thereby compensating the output light L1 according to the junction temperature TJ1. Therefore, the light-emitting device 100 is not required to obtain the temperature of the light-emitting diode 110_1 by using a temperature sensor. In this way, a volume of the light-emitting device 100 will not be increased.

In addition, during the second period, the control circuit 120 provides the detection signal SDE to the light-emitting diode 110_2 to receive a sensing voltage value VD2 of the light-emitting diode 110_2, and obtains a junction temperature TJ2 of the light-emitting diode 110_2 according to the sensing voltage value VD2. Therefore, the control circuit 120 compensates the output light L2 according to the junction temperature TJ2. Similarly, during the second period, the control circuit 120 provides the detection signal SDE to the light-emitting diode 110_3 to receive a sensing voltage value VD3 of the light-emitting diode 110_3, and obtains a junction temperature TJ3 of the light-emitting diode 110_3 according to the sensing voltage value VD3. Therefore, the control circuit 120 compensates the output light L3 according to the junction temperature TJ3.

In this embodiment, the detection signal SDE is a detection current signal. For example, the detection signal SDE may provide a forward current value to the light-emitting diodes 110_1, 110_2, and 110_3. The forward current value is, for example, 5 milliamperes (mA), but the disclosure is not limited thereto. The sensing voltage value VD1 is a forward bias voltage value generated by the light-emitting diode 110_1 during the second period according to the forward current value. The sensing voltage value VD2 is a forward bias voltage value generated by the light-emitting diode 110_2 during the second period according to the forward current value. Similarly, the sensing voltage value VD3 is a forward bias voltage value generated by the light-emitting diode 110_3 during the second period according to the forward current value.

In this embodiment, the control circuit 120 controls the light-emitting diode 110_1 to provide the output light L1 by using a driving signal SDR1, controls the light-emitting diode 110_2 to provide the output light L2 by using a driving signal SDR2, and controls the light-emitting diode 110_3 to provide the output light L3 by using a driving signal SDR3. The driving signals SDR1, SDR2, and SDR3 each have a duty cycle. The control circuit 120 adjusts the duty cycles of the driving signals SDR1, SDR2, and SDR3 according to the junction temperatures TJ1, TJ2, and TJ3.

For example, the output lights L1, L2, and L3 may be lights having different colors or wavelengths.

In this embodiment, the three light-emitting diodes 110_1, 110_2, and 110_3 are taken as an example. The light-emitting device in the disclosure may include one or more light-emitting diodes of any type, and is not limited to the number and type of the light-emitting diodes in this embodiment.

In this embodiment, the control circuit 120 receives a control signal SC and generates the driving signals SDR1, SDR2, and SDR3 according to the control signal SC.

In this embodiment, taking the light-emitting diode 110_1 as an example, the control circuit 120 determines whether the light-emitting diode 110_1 provides the output light L1 lower than set brightness during the first period according to the driving signal SDR1. For example, the control circuit 120 may determine brightness of the output light L1 according to the duty cycle of the driving signal SDR1. When the light-emitting diode 110_1 provides the output light L1 lower than the set brightness during the first period (for example, the output light L1 is not provided, or the low-brightness output light L1 is provided), the control circuit 120 will stop providing the detection signal SDE during the second period after the first period during which the output light L1 lower than the set brightness is provided. In this way, when the light-emitting diode 110_1 does not provide the output light L1 or provides the low-brightness output light L1, the light-emitting diode 110_1 will not emit the light or flicker due to the detection signal SDE during the second period. When the light-emitting diode 110_1 provides the output light L1 greater than or equal to the set brightness during the first period, the control circuit 120 will provide the detection signal SDE during the second period.

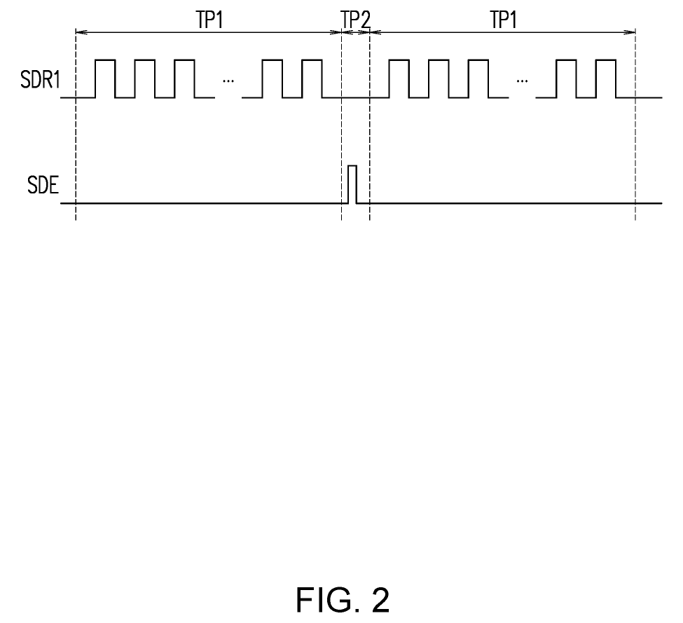

Referring to FIGS. 1 and 2, FIG. 2 is a timing diagram according to an embodiment of the disclosure. In this embodiment, the control circuit 120 provides the driving signal SDR1 to the light-emitting diode 110_1 during a first period TP1. The driving signal SDR1 may be a pulse-width modulation (PWM) signal. The control circuit 120 provides the detection signal SDE to the light-emitting diode 110_1 during a second period TP2. It should be noted that a time length of the second period TP2 is shorter than a time length of the first period TP1. For example, the time length of the second period TP2 may be several milliseconds or less than 1 second. For example, the time length of the second period TP2 may be less than 1 millisecond. Therefore, during the second period TP2, the detection signal SDE is insufficient to affect changes in the junction temperatures TJ1, TJ2, and TJ3. Therefore, an error caused by the detection signal SDE to the junction temperatures TJ1, TJ2, and TJ3 may be ignored.

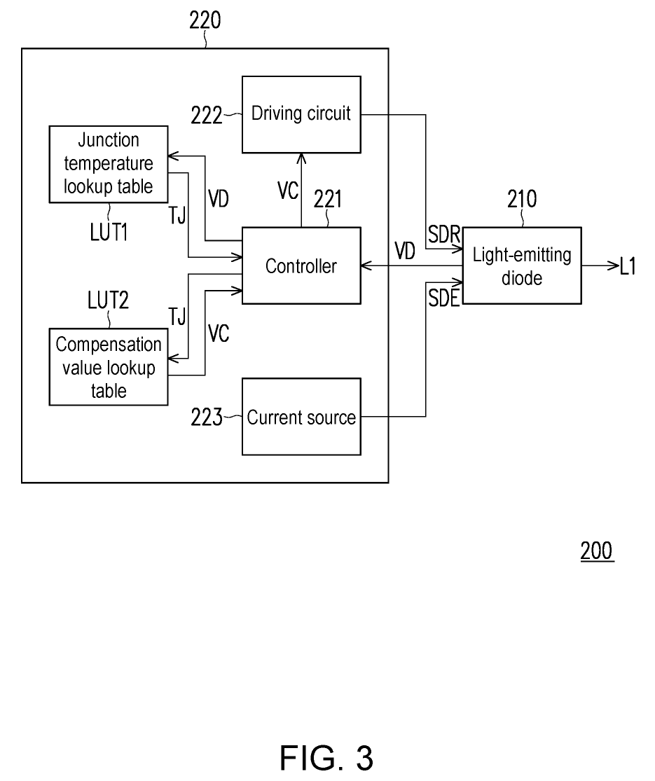

Referring to FIG. 3, FIG. 3 is a schematic diagram of a light-emitting device according to an embodiment of the disclosure. In this embodiment, a light-emitting device 200 includes a light-emitting diode 210 and a control circuit 220. The control circuit 220 includes a junction temperature lookup table LUT1 and a controller 221. The junction temperature lookup table LUT1 records multiple junction temperatures corresponding to multiple sensing voltage values. The controller 221 is coupled to the junction temperature lookup table. The controller 221 obtains a junction temperature TJ by using the junction temperature lookup table LUT1 and a received sensing voltage value VD.

In this embodiment, the controller 221 is, for example, a central processing unit (CPU) or other programmable general-purpose or special-purpose microprocessors, a digital signal processor (DSP), a programmable controller, an application specific integrated circuit (ASIC), a programmable logic device (PLD), or other similar devices or a combination of the foregoing devices, which may load and execute computer programs.

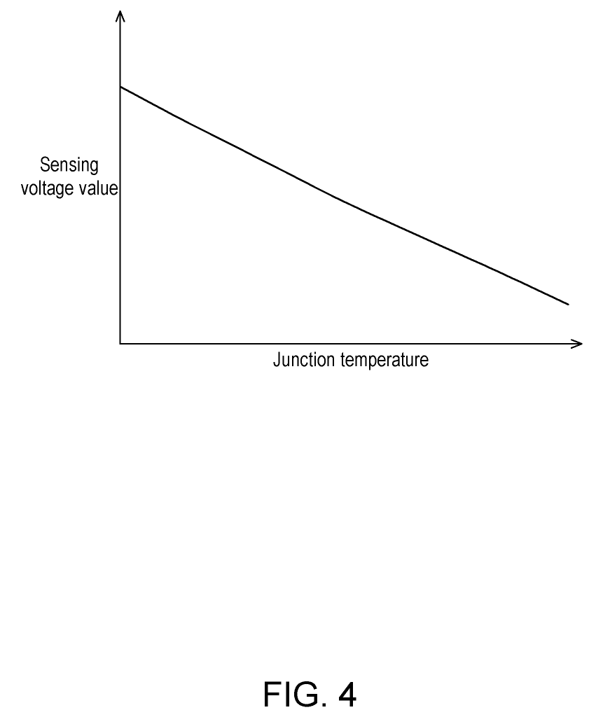

Referring to FIGS. 3 and 4, FIG. 4 is a schematic diagram of a relationship between a sensing voltage value and a junction temperature according to an embodiment of the disclosure. For example, when the forward current value is fixed, the higher the junction temperature TJ of the light-emitting diode 210 is, the lower the sensing voltage value VD of the light-emitting diode 210 is. The lower the junction temperature TJ of the light-emitting diode 210 is, the higher the sensing voltage value VD of the light-emitting diode 210 is. The junction temperature lookup table LUT1 records a relationship between the sensing voltage value VD and the junction temperature TJ as shown in FIG. 4. Therefore, based on FIG. 4, the controller 221 may obtain the junction temperature TJ of the light-emitting diode 210 according to the received sensing voltage value VD.

In this embodiment, FIG. 4 may be provided by a manufacturer or a supplier of the light-emitting diode 210.

In this embodiment, a trend in FIG. 4 may be different depending on a type and/or a light color of the light-emitting diode 210.

Returning back to FIG. 3, in this embodiment, the control circuit 220 further includes a driving circuit 222 and a compensation value lookup table LUT2. The driving circuit 222 is coupled to the light-emitting diode 210 and the controller 221. The driving circuit 222 outputs a driving signal SDR during the first period. The compensation value lookup table LUT2 is coupled to the controller 221. The compensation value lookup table LUT2 records multiple compensation values corresponding to multiple different junction temperatures. The controller 221 obtains a compensation value VC corresponding to the current junction temperature TJ by using the compensation value lookup table, and controls the driving circuit 222 according to the compensation value VC. Therefore, the driving circuit 222 may adjust the duty cycle of the driving signal SDR according to the compensation value VC.

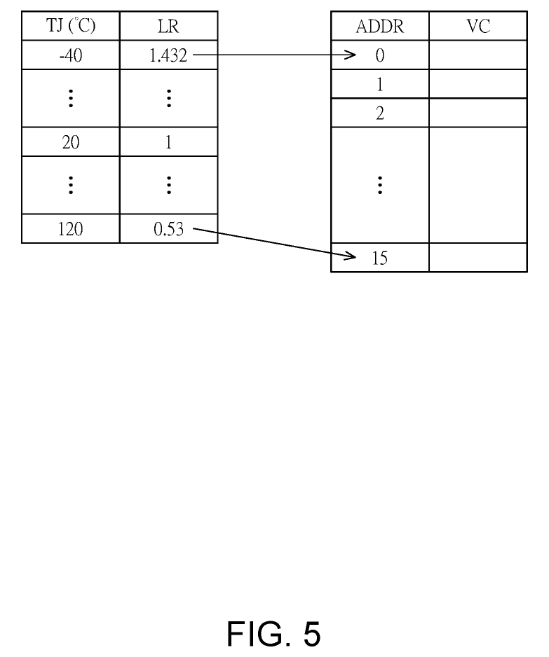

Referring to FIGS. 3 and 5, FIG. 5 is a schematic diagram of a compensation value lookup table according to an embodiment of the disclosure. In this embodiment, the compensation value lookup table LUT2 records multiple junction temperatures TJ, multiple brightness ratios LR, multiple addresses ADDR, and multiple compensation values VC. In this embodiment, the brightness ratio is a ratio between the brightness of the output light L1 and reference brightness. The brightness ratio may be a quotient of the brightness of the output light L1 divided by the reference brightness. When the junction temperature TJ of the light-emitting diode 210 is equal to a reference temperature (e.g., 20 °C.), the light-emitting diode 210 provides a reference output light having the reference brightness. Therefore, the controller 221 obtains the brightness ratio LR of the brightness of the output light L1 and the reference brightness according to the junction temperature TJ, and obtains the compensation value VC according to the brightness ratio LR.

For example, when the junction temperature TJ of the light-emitting diode 210 is equal to “-40 °C”, the brightness ratio LR is equal to “1.432”, but the disclosure is not limited thereto. The address ADDR of the compensation value lookup table LUT2 is “0”. Therefore, the controller 221 may obtain the compensation value VC of the corresponding address ADDR being “0”.

For another example, when the junction temperature TJ of the light-emitting diode 210 is equal to “120 °C”, the brightness ratio LR is equal to “0.53”, but the disclosure is not limited thereto. The address ADDR of the compensation value lookup table LUT2 is “15”. Therefore, the controller 221 may obtain the compensation value VC the corresponding address ADDR being “15”. The compensation values VC corresponding to different addresses ADDR are different from each other.

Based on different compensation values VC, the duty cycles of the driving signals SDR are also different. Therefore, the control circuit 220 may compensate brightness performance of the light-emitting diode 210 at different junction temperatures TJ based on the compensation value VC. In this embodiment, the values in the compensation value lookup table LUT2 may be adjusted according to the actual performance of the light-emitting diode 210. The disclosure is not limited to the values in the compensation value lookup table LUT2 in this embodiment.

Returning to FIG. 3, in this embodiment, the control circuit 220 further includes a current source 223. The current source 223 is coupled to the light-emitting diode 210. The current source 223 provides the detection signal SDE during the second period.

Specifically, the driving circuit 222 provides the driving signal SDR during the first period, and stops providing the driving signal SDR during the second period. The current source 223 stops providing the detection signal SDE during the first period, and provides the detection signal SDE during the second period.

In this embodiment, the junction temperature lookup table LUT1 and the compensation value lookup table LUT2 may be respectively implemented by at least one memory circuit. In some embodiments, the controller 221 may calculate the junction temperature TJ. Therefore, the junction temperature lookup table LUT1 may be omitted. In some embodiments, the controller 221 may calculate the compensation value VC. Therefore, the compensation value lookup table LUT2 may be omitted.

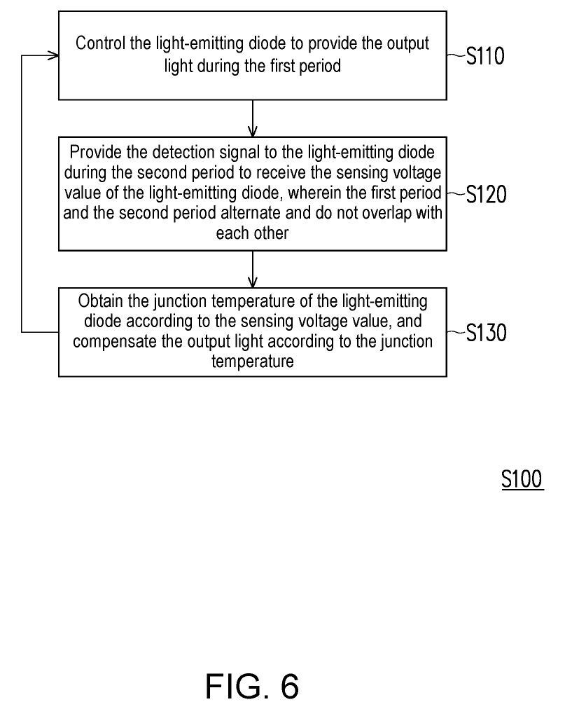

Referring to FIGS. 1 and 6, FIG. 6 is a flow chart of an operating method according to an embodiment of the disclosure. In this embodiment, an operating method S100 is applicable to the light-emitting device 100. The operating method S100 includes steps S110, S120, and S130. Taking the light-emitting diode 110_1 as an example, in step S110, the light-emitting device 100 controls the light-emitting diode 110_1 to provide the output light L1 during the first period. In step S120, the light-emitting device 100 provides the detection signal SDE to the light-emitting diode 110_1 to receive the sensing voltage value VD1 during the second period. In this embodiment, the first period and the second period alternate and do not overlap with each other. In step S130, the light-emitting device 100 obtains the junction temperature TJ1 of the light-emitting diode 110_1 according to the sensing voltage value VD1, and compensates or adjusts the output light L1 according to the junction temperature TJ1. Next, the light-emitting device 100 returns to the operation of step S110.

In this embodiment, implementation details of steps S110, S120, and S130 have been clearly described in the embodiments of FIGS. 1 to 5. Therefore, the same details will not be repeated in the following.

It should be understood that the light-emitting device 100 may control the light-emitting diodes 110_2 and 110_3 based on the operating method S100. In addition, the operating method S100 is also applicable to the light-emitting device 200 in FIG. 3.

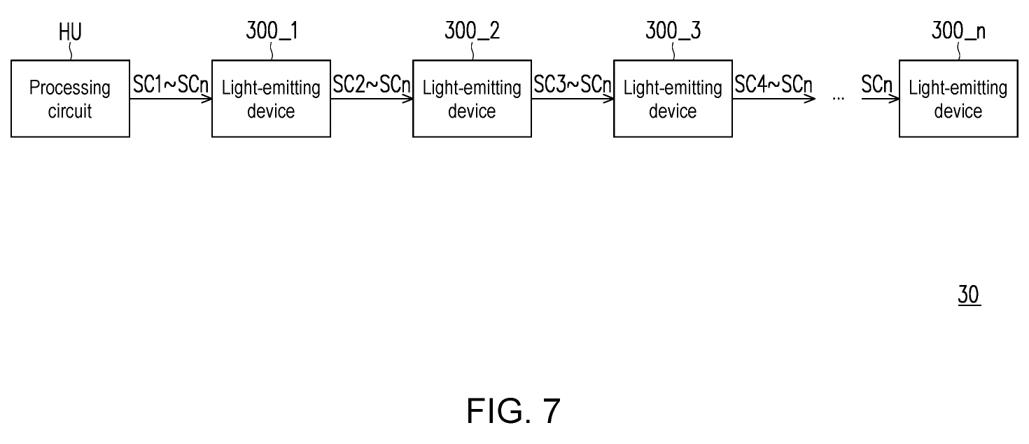

Referring to FIG. 7, FIG. 7 is a schematic diagram of a system according to an embodiment of the disclosure. In this embodiment, a system 30 includes light-emitting devices 300_1 to 300_n and a processing circuit HU. The light-emitting devices 300_1 to 300_n are connected in series to each other. For example, the light-emitting device 300_1 is connected between the processing circuit HU and the light-emitting device 300_2. The light-emitting device 300_2 is connected between the light-emitting device 300_1 and the light-emitting device 300_3, and the rest may be derived by analogy. The light-emitting devices 300_1 to 300_n may be implemented by the light-emitting device 100 in FIG. 1 or the light-emitting device 200 in FIG. 3 respectively.

In this embodiment, the processing circuit HU provides control signals SC1 to SCn in sequence. The light-emitting device 300_1 receives the control signal SC1 and provides control signals SC2 to SCn to the light-emitting device 300_2. The light-emitting device 300_1 drives the light-emitting diode in the light-emitting device 300_1 according to the control signal SC1. The light-emitting device 300_2 receives the control signal SC2 and provides control signals SC3 to SCn to the light-emitting device 300_3, and the rest may be derived by analogy. The processing circuit HU may be a control source circuit or a control host. The control signals SC1 to SCn may be implemented by at least one signal stream.

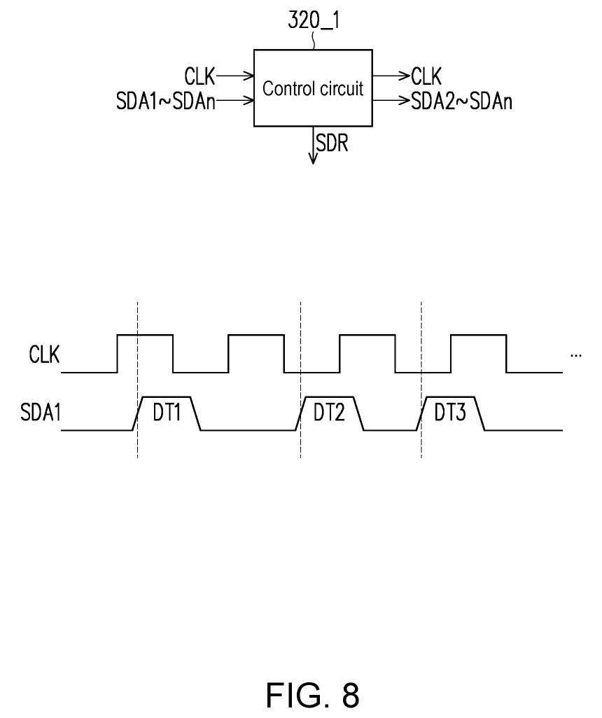

Referring to FIGS. 7 and 8, FIG. 8 is a timing diagram of a control signal according to an embodiment of the disclosure. The control signal SC1 includes a clock signal CLK and a data signal SDA1. The control signal SC2 includes the clock signal CLK and a data signal SDA2. Similarly, the control signal SCn includes the clock signal CLK and a data signal SDAn. The data signals SDA1 to SDAn are implemented by the signal streams. In this embodiment, taking the light-emitting device 300_1 as an example, the control circuit 320_1 receives the control signal SC1. The control circuit 320_1 of the light-emitting device 300_1 decodes a data signal SDA by using the clock signal CLK to generate the driving signal SDR. Furthermore, the control circuit 320_1 may decode multiple data of the data signal SDA1 by using a timing of the clock signal CLK to generate multiple bits of a control code, and drives the driving signal SDR according to the bits.

The control circuit 320_1 may generate a first bit of the control code according to data DT1 of the data signal SDA1, generate a second bit of the control code according to data DT2 of the data signal SDA1, generate a third bit of the control code according to data DT3 of the data signal SDA1, and the rest may be derived by analogy.

For example, when a rising edge of the data DT1 of the data signal SDA1 corresponds to a first logic value (e.g., a high logic value, but the disclosure is not limited thereto) of the clock signal CLK, the control circuit 320_1 generates the first bit having a first bit value (e.g., “1”, but the disclosure is not limited thereto). When a rising edge of the data DT2 of the data signal SDA1 corresponds to a second logic value (e.g., a low logic value, but the disclosure is not limited thereto) of the clock signal CLK, the control circuit 320_1 generates the second bit having a second bit value (e.g., “0”, but the disclosure is not limited thereto). When a rising edge of the data DT3 of the data signal SDA1 corresponds to a third logic value of clock signal CLK, the control circuit 320_1 generates the third bit having a third value, and the rest may be derived by analogy.

In addition, the control circuit 320_1 provides the clock signal CLK and the data signals SDA2 to SDAn to the light-emitting device 300_2.

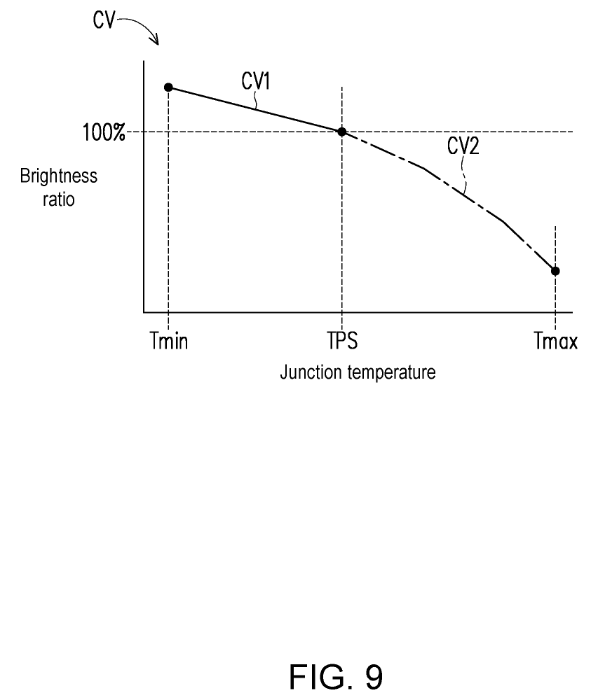

Referring to FIGS. 3 and 9, FIG. 9 is a schematic diagram of a relationship between a junction temperature and a brightness ratio according to an embodiment of the disclosure. In this embodiment, FIG. 9 shows a relationship curve CV between the junction temperature TJ and the brightness ratio. The controller 221 sets a brightness ratio corresponding to an initial temperature TPS to “100%” or “1”. Before leaving a factory, the controller 221 is tested based on the initial temperature TPS. Therefore, the initial temperature TPS is a compensation reference point. The initial temperature TPS is between a minimum junction temperature Tmin (e.g., “-40°C”) and a maximum junction temperature Tmax (e.g., “80°C”). For example, the initial temperature TPS may be any temperature between 20 °C and 30 °C, but the disclosure is not limited thereto.

In this embodiment, the relationship curve CV is divided into a first curve CV1 in a first temperature interval and a second curve CV2 in a second temperature interval by the initial temperature TPS. The first curve CV1 shows a first junction temperature-brightness ratio trend where the junction temperature TJ is lower than the initial temperature TPS. The second curve CV2 shows a second junction temperature-brightness ratio trend where the junction temperature TJ is higher than the initial temperature TPS.

In this embodiment, the first junction temperature-brightness ratio trend of the first curve CV1 is different from the second junction temperature-brightness ratio trend of the second curve CV2. In other words, when the junction temperature TJ is lower than the initial temperature TPS, the controller 221 obtains the brightness ratio according to the first junction temperature-brightness ratio trend of the first curve CV1. When the junction temperature TJ is higher than the initial temperature TPS, the controller 221 obtains the brightness ratio according to the second junction temperature-brightness ratio trend of the second curve CV2.

For example, the first curve CV1 is a first-degree equation (or referred to as a linear equation). The second curve CV2 is, for example, a quadratic equation. However, the disclosure is not limited to curve patterns of the first curve CV1 and the second curve CV2. Therefore, the controller 221 obtains the brightness ratio according to different junction temperature-brightness ratio trends corresponding to different temperature intervals.

Therefore, when the junction temperature TJ is lower than the initial temperature TPS, the control circuit 120 may obtain the brightness ratio based on the first curve CV1 and perform low-temperature compensation on the output lights L1, L2, and L3 based on the brightness ratio. When the junction temperature TJ is higher than the initial temperature TPS, the control circuit 120 may obtain the brightness ratio based on the second curve CV2 and perform high-temperature compensation on the output lights L1, L2, and L3 based on the brightness ratio.

Generally speaking, in the current light-emitting devices, one of the minimum junction temperature Tmin (e.g., -40 °C) and the maximum junction temperature Tmax (e.g., 80 °C) is used as the compensation reference point. In addition, the current light-emitting devices obtain the brightness ratio by only using a fixed single slope. Therefore, the greater a temperature difference between the temperature and the initial temperature, the greater an error in the brightness ratio will be. For example, if the light-emitting device uses the minimum junction temperature Tmin as the initial temperature TPS, the error in the brightness ratio will increase as the temperature increases. Therefore, when the junction temperature TJ reaches the maximum junction temperature Tmax, the temperature difference is equal to “120 °C”. Therefore, the error in the brightness ratio will be the largest, and a risk of compensation distortion will increase.

In this embodiment, the initial temperature TPS may be “20 °C”. Therefore, when the junction temperature TJ reaches the maximum junction temperature Tmax, the temperature difference is only “60 °C”. In addition, when the junction temperature TJ is higher than the initial temperature TPS, the controller 221 obtains the brightness ratio according to the second curve CV2. It may be seen that compared to the current light-emitting devices, the risk of compensation distortion in this embodiment is greatly reduced. When the junction temperature TJ reaches the minimum junction temperature Tmin, the temperature difference is only “60 °C”. In addition, when the junction temperature TJ is lower than the initial temperature TPS, the controller 221 obtains the brightness ratio according to the first curve CV1.

In some embodiments, at least one of the first curve CV1 and the second curve CV2 may be divided into multiple curves having different junction temperature-brightness ratio trends based on the temperatures different from the initial temperature TPS.

In this embodiment, the relationship curve CV may be burned or stored in the compensation value lookup table LUT2.

Based on the above, the light-emitting device provides the detection signal to the light-emitting diode to receive the sensing voltage value of the light-emitting diode during the second period, obtains the junction temperature of the light-emitting diode according to the sensing voltage value, and compensates the output light according to the junction temperature. The light-emitting device in the disclosure is not required to obtain the temperature of the light-emitting diode by using the temperature sensor. In this way, the volume of the light-emitting device will not be increased. In addition, the time length of the second period is shorter than the time length of the first period. Therefore, during the second period, the detection signal is insufficient to affect the changes in the junction temperature of the light-emitting diode. In this way, the error caused by the detection signal to the junction temperature may be ignored.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A light-emitting device, comprising:
a light-emitting diode; and
a control circuit coupled to the light-emitting diode, and configured to control the light-emitting diode to provide an output light during a first period and provide a detection signal to the light-emitting diode to receive a sensing voltage value of the light-emitting diode during a second period,
wherein the first period and the second period alternate and do not overlap with each other, and
wherein the control circuit obtains a junction temperature of the light-emitting diode according to the sensing voltage value, and compensates the output light according to the junction temperature.

2. The light-emitting device according to claim 1, wherein the control circuit comprises:
a junction temperature lookup table configured to record a plurality of junction temperatures corresponding to a plurality of sensing voltage values; and
a controller coupled to the junction temperature lookup table and configured to obtain the junction temperature by using the junction temperature lookup table and the received sensing voltage value.

3. The light-emitting device according to claim 2, wherein
the control circuit controls the light-emitting diode to provide the output light by using a driving signal, and
the control circuit adjusts a duty cycle of the driving signal according to the junction temperature.

4. The light-emitting device according to claim 3, wherein
the control circuit determines whether the light-emitting diode provides the output light lower than set brightness during the first period according to the driving signal, and
when it is determined that the output light lower than the set brightness is provided during the first period, the control circuit stops providing the detection signal during the second period after the first period during which the output light lower than the set brightness is provided.

5. The light-emitting device according to claim 3, wherein the control circuit further comprises:
a driving circuit coupled to the light-emitting diode and the controller, and configured to output the driving signal during the first period;
a compensation value lookup table coupled to the controller and configured to record a plurality of compensation values corresponding to the junction temperatures,
wherein the controller obtains a compensation value corresponding to the current junction temperature by using the compensation value lookup table, and controls the driving circuit according to the compensation value, and
wherein the driving circuit adjusts the duty cycle of the driving signal according to the compensation value.

6. The light-emitting device according to claim 5, wherein
when the junction temperature of the light-emitting diode is equal to a reference temperature, the light-emitting diode provides a reference output light having reference brightness, and
the controller obtains a brightness ratio of brightness of the output light and the reference brightness according to the junction temperature, and obtains the compensation value according to the brightness ratio.

7. The light-emitting device according to claim 6, wherein
when the junction temperature is lower than an initial temperature, the controller obtains the brightness ratio based on a first junction temperature-brightness ratio trend,
when the junction temperature is higher than the initial temperature, the controller obtains the brightness ratio based on a second junction temperature-brightness ratio trend, and
the first junction temperature-brightness ratio trend is different from the second junction temperature-brightness ratio trend.

8. The light-emitting device according to claim 3, wherein the control circuit receives a control signal and generates the driving signal according to the control signal.

9. The light-emitting device according to claim 8, wherein
the control signal comprises a clock signal and a data signal, and
the control circuit decodes the data signal by using the clock signal to generate the driving signal.

10. The light-emitting device according to claim 1, wherein the detection signal is a detection current signal.

11. The light-emitting device according to claim 1, wherein the control circuit comprises:
a current source coupled to the light-emitting diode and configured to provide the detection signal during the second period.

12. The light-emitting device according to claim 1, wherein a time length of the second period is shorter than a time length of the first period.

13. An operating method for a light-emitting device, wherein the light-emitting device comprises a light-emitting diode, and the operating method comprises:
controlling the light-emitting diode to provide an output light during a first period;
providing a detection signal to the light-emitting diode to receive a sensing voltage value of the light-emitting diode during a second period, wherein the first period and the second period alternate and do not overlap with each other; and
obtaining a junction temperature of the light-emitting diode according to the sensing voltage value, and compensating the output light according to the junction temperature.

14. The operating method according to claim 13, wherein the step of compensating the output light according to the junction temperature comprises:
adjusting a duty cycle of a driving signal according to the junction temperature; and
controlling the light-emitting diode to provide the output light by using the driving signal.

15. The operating method according to claim 14, further comprising:
determining whether the light-emitting diode provides the output light lower than set brightness during the first period according to the driving signal; and
when it is determined that the output light lower than the set brightness is provided during the first period, the detection signal is stopped from being provided during the second period after the first period during which the output light lower than the set brightness is provided.

16. The operating method according to claim 14, wherein when the junction temperature of the light-emitting diode is equal to a reference temperature, the light-emitting diode provides a reference output light having reference brightness, and the step of adjusting the duty cycle of the driving signal according to the junction temperature comprises:
obtaining a brightness ratio of brightness of the output light and the reference brightness according to the junction temperature, and obtaining a compensation value according to the brightness ratio; and
adjusting the duty cycle of the driving signal according to the compensation value.

17. The operating method according to claim 16, wherein the step of obtaining the brightness ratio of the brightness of the output light and the reference brightness according to the junction temperature comprises:
when the junction temperature is lower than an initial temperature, obtaining the brightness ratio based on a first junction temperature-brightness ratio trend,
when the junction temperature is higher than the initial temperature, obtaining the brightness ratio based on a second junction temperature-brightness ratio trend, and
the first junction temperature-brightness ratio trend is different from the second junction temperature-brightness ratio trend.

18. The operating method according to claim 13, wherein the detection signal is a detection current signal.

19. The operating method according to claim 13, wherein a time length of the second period is shorter than a time length of the first period.
